(19) United States
(12) Patent Application Publication
(10) Pub. No.: US 2006/0266763 A1
(43) Pub. Date: Nov. 30, 2006

(54) Automated medication dispensing apparatus

(76) Inventor: Katrin Svabo Bech, Milano (IT)

Correspondence Address: BROWDY AND NEIMARK, P.L.L.C.;624 NINTH STREET, NW, SUITE 300, WASHINGTON, DC, 20001-5303, US

(21) Appl. No.: 11/139,699

(22) Filed: May 31, 2005

(51) Int. Cl. G07F 11/00

(52) U.S. Cl. 221/83

(57) ABSTRACT

Apparatus for automated dispensing of pharmaceutical doses in discrete solid form. Such apparatus comprises at least a container provided with a compartment for storing the pharmaceutical doses to be dispensed. A dispenser is associated with said at least a container for dispensing prescribed pharmaceutical doses according to medication dispensing information stored in a portable memory. Furthermore, the dispenser is provided with reader/writer and processor devices for, respectively, reading and processing the information stored in such memory. A dispensing mechanism of said pharmaceutical doses includes a first opening to put the storing compartment in communication with the dispenser. A vibration device for making the pharmaceutical doses stored in the compartment vibrate and allowing the release of at least one pharmaceutical dose through the first opening.

### FIELD OF THE INVENTION

The present invention relates generally to an apparatus for use in dispensing oral medication, particularly in pill or capsule form or the like for administration to a patient. More particularly, this invention relates to an improved medication apparatus designed for automatic dispensing of one or more medications in accordance with prescription schedules.

### BACKGROUND

A wide variety of automatic and/or programmable medication dispensing devices are known in the art, wherein one or more medications are dispensed for administration to a patient or patients in a timely manner. Some of these dispensing devices have been designed for use in a hospital for storing different medications for a plurality of patients. Other dispensing devices have been designed for use by an individual patient, such as at patient bedside in a hospital or for in-home environment use.

U.S. Pat. No. 4,695,954 discloses a system, apparatus and method, for dispensing medications prescribed by a doctor.

A portable memory device (such as a magnetic card) is used to store data representing prescription information. A container having a plurality of individual compartments is filled at the pharmacy with medications in accordance with the prescription information.

The dispenser includes apparatus which reads the prescription information from the memory device and makes medications within the individual compartments available to the patient only at prescribed times. The medication dispenser also includes apparatus for monitoring whether or not the patient is complying with the prescribed medication schedule. Patient compliance information is stored within the memory device.

U.S. Pat. No. 5,522,525 discloses a medication dispenser station for automatic dispensing of medication in accordance with a prescription schedule for a patient. The station receives and supports a plurality of medication-containing cassettes in a vertical stack, with the cassettes having aligned discharge openings defining an open discharge chute. The cassettes include scannable data identifying the medication and prescription schedule applicable to each cassette. A station head scans the data to input information regarding the medication and administration schedule for each cassette to a station control unit.

A medication dispenser known is the so called MD2, produced by Interactive Medical Developments, in Webster City, Iowa, USA. The dispenser is filled up with plastic cups, into which dosages of medication are placed. Should the patients miss their recommended dosage time by over 90 minutes, the product will ring one of five relatives or alternatively the patient's doctor.

Furthermore, medication dispensing devices are described in U.S. Pat. No. 6,581,797 and in U.S. Pat. No. 4,811,764.

### SUMMARY OF THE INVENTION

The object of the present invention is to provide an improved automated medication dispensing apparatus compared with the known medication dispensers.

Particularly, the present invention is an apparatus for automated dispensing of pharmaceutical doses in discrete solid form, such apparatus comprising:
at least a container provided with a compartment for storing the pharmaceutical doses to be dispensed;
dispenser associable with said at least a container for dispensing prescribed pharmaceutical doses according to medication dispensing information stored in portable memory; said dispenser being provided with reader/writer and processor devices for, respectively, reading and processing the information stored in such memory;
dispensing mechanism of said pharmaceutical doses including a first opening to put the storing compartment in communication with the dispenser, and
vibration device for making the pharmaceutical doses stored in the compartment vibrate and allowing the release of at least one pharmaceutical dose through the first opening.

### BRIEF DESCRIPTION OF THE DRAWINGS

The characteristics and the advantages of the present invention will be understood from the following detailed description of an exemplary non-limiting embodiment thereof with reference to the annexed figures, in which:

FIG. 1 is a front view of the medication dispensing apparatus according with the invention;

FIG. 2 is a perspective view of a cross-section of a container used in the apparatus of FIG. 1;

FIG. 3 is a perspective view including a partial cross-section of the medication dispensing apparatus of FIG. 1;

FIG. 4 is a block scheme indicating components comprised in the apparatus of FIG. 1;

FIG. 5 A-F, schematically show operative sequences related to a dispensing mechanism comprised in the container of FIG. 2.

### DETAILED DESCRIPTION OF THE PREFERRED EMBODIMENTS

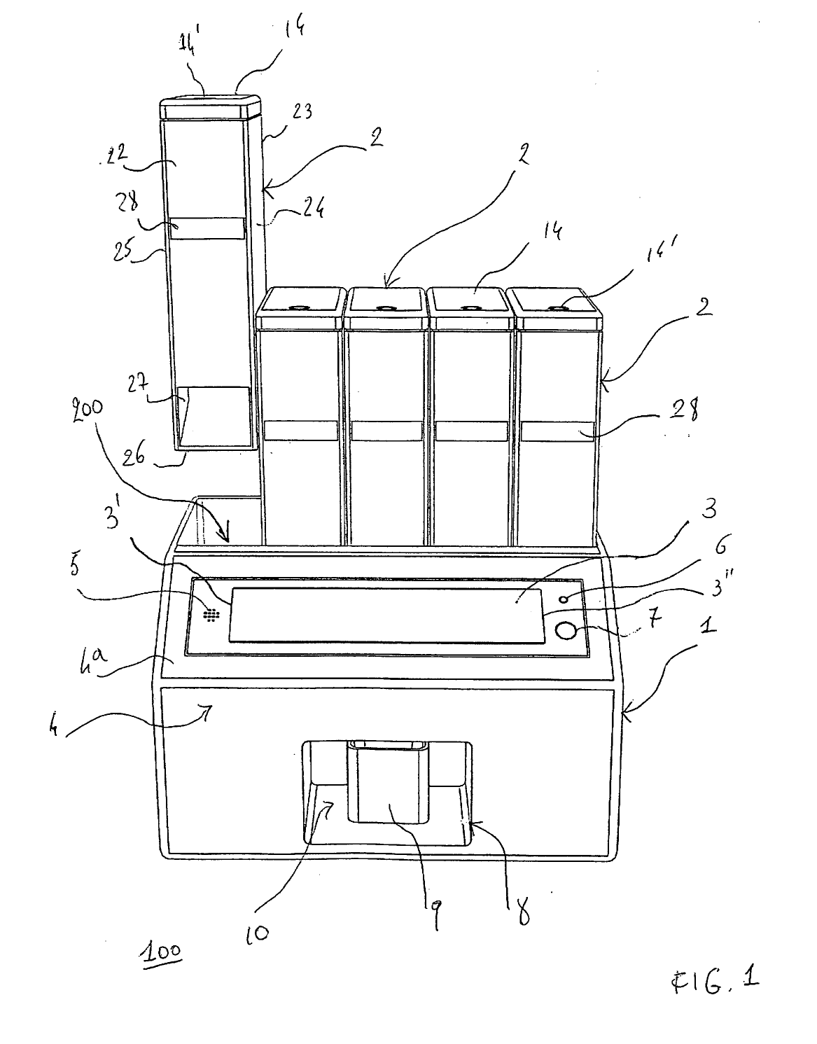

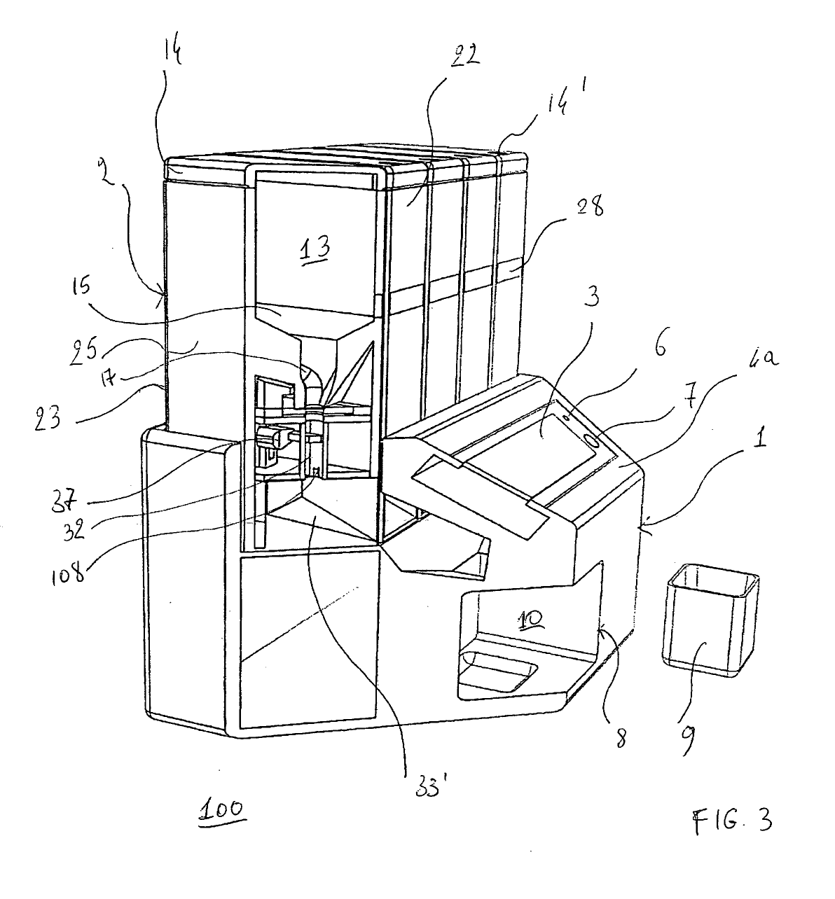

In accordance with FIGS. 1, 2, 3 and 4 a preferred embodiment of a medication dispensing apparatus 100 according with the invention is described.

Particularly, the apparatus 100 of the present invention is intended primarily for use by a single patient. Furthermore, such apparatus 100 can be used both in a home environment and in a hospital (or caregiving environment).

The apparatus 100 comprises a dispenser 1 and a plurality of containers 2, each insertable in this dispenser 1. Particularly, each container 2 is insertable in a space 200 of such dispenser 1.

According with the example of FIG. 1, the apparatus 100 comprises five containers 2 of parallelepiped shape and each one is suitable to store a medication to be dispensed.

It should be observed that the dispenser 1 and the containers 2 are made of plastic materials, such as the Acetyl Butyl Styrene (ABS).

Preferably, the medications dispensed by apparatus 100 are pharmaceutical doses in discrete solid form. Particularly, with pharmaceutical doses we refer to pills, capsules, tablets or other medications of the like.

It should be observed that each container 2 is designed to be filled with pharmaceutical doses all of the same kind, such as pills having the same shape and size.

Moreover, the dispenser 1 includes a control device 101 such as a microprocessor or microcontroller which is suitable to coordinate and control all functions of the dispensing apparatus 100. For example, the dispenser 1 may include the microcontroller PIC16F877.

In addition, such dispenser 1 may include a random access memory (RAM) 102 and a read only memory (ROM) 103. Both memories 102 and 103 are interfaced with the microcontroller 101 for exchanging data stored within them.

The microcontroller 101, also, interacts (or contains) with a Real Time Clock Counter (RTCC) 104 acting as a timer for the apparatus 100.

Furthermore, the dispenser 1 comprises a reader/writer device 105 which under control of microcontroller 101 reads data from and writes data to a portable memory device 106. Such portable memory 106 is, for example, a smart card provided with a EEPROM memory. For this purpose, the smart card 106 is insertable in the dispenser 1 to be read/written by the reader/writer device 105.

The smart card 106 is used to store data representing a wide variety of information. For example, it may include patient identification data, such as name, address, identification number and all other information that can be used for recordkeeping purposes. Moreover, the smart card 106 may include medication data comprising a complete description of the patient medication program. Particularly, this description includes a list of all medications which the patient has to receive, dosage of each and a schedule identifying the times at which the medications are to be taken.

The apparatus 100 further comprises a display 3 mounted to an upper portion 4a of a front face 4 of the dispenser 1. In a preferred embodiment, such display 3 is a commercially available digital display of LCD type driven by microcontroller 101. For example, such display 3 may display the correct time of day, the name of a pharmaceutical dose to be taken at a prescribed time and all information useful to help a patient in taking the prescribed pharmaceutical dose.

The medication dispensing apparatus 100 produces also both audio and visual alarms to alert the patient at times pharmaceutical doses are to be taken.

Particularly, such audio alarm is provided by an audio transducer, such as a speaker 5, mounted to the upper portion 4a of front face 4 of dispenser 1 near a first edge 3′ of LCD display 3. The speaker 5 is controlled by microcontroller 101 so that, at the prescribed times, microcontroller 101 causes speaker 5 to generate an audio alarm, such as a beeping tone.

A visual alarm, such as a light 6 is positioned near a second edge 3″ of LCD display 3 opposite of the first side 3′. For example, such light 6 is a LED interfaced with microcontroller 101 so that it is lit at the prescribed times, thereby providing the patient with a visual indication that pharmaceutical doses are to be taken. This alarm is particularly useful for older patients who are often hard of hearing and thereby unable to hear the audio alarm generated by speaker 5.

Both speaker 5 and LED 6 can be, selectively, turned ON/OFF by means of switches provided in the dispenser 1.

Further, the dispenser 1 includes a button 7 located in the upper portion 4a of front face 4 near the second edge 3″ of display 3. This button 7 has to be pressed to activate the dispensation of a pharmaceutical dose.

The dispenser 1 includes a frontal opening 8 in the front face 4 below the LCD display 3. Such frontal opening 8 allows to access a delivery area 10 which is suitable for housing a removable cup 9 for receiving the dispensed pharmaceutical doses.

Mains electricity, such as a standard 110-120 Volt AC electrical outlet, provides electrical energy for all electrical and electronic devices within dispensing apparatus 100 through a suitable power supply. In a further embodiment, the apparatus 100 may include rechargeable batteries.

According with FIG. 1, each container 2 comprises a front wall 22 opposite to a rear wall 23 and a first 24 and second 25 side walls opposite each other. Furthermore, the container 2 comprises a base wall 26 and an upper lid 14 that can be opened acting on an opening button 14′.

As shown in FIG. 1, the front wall 22 comprises a delivery opening 27 located in a lower portion of container 2 near the base wall 26. Such delivery opening 27 communicates with the delivery area 10 of dispenser 1 allowing to dispense the pharmaceutical dose housed in the container 2.

Furthermore, each container 2 may comprise a translucent section 28 in the front wall 22. Particularly, sections used are clear in order to make a container 2 immediately distinguishable from each other by making visible the contained medication. In addition, the front wall 22 may comprise a label indicating the name of the pharmaceutical dose housed in the corresponding container 2.

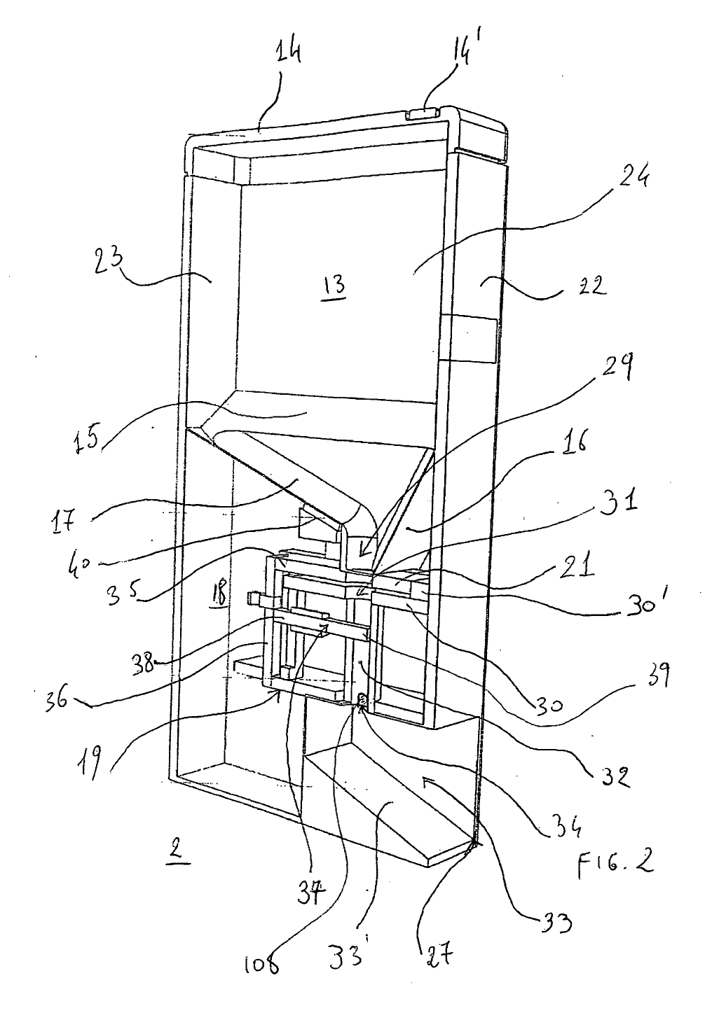

According with FIG. 2 an example of container 2 of the dispensing apparatus 100 of the invention is described in a greater detail. Particularly, FIG. 2 is a longitudinal cross section of container 2 showing an internal structure of such container 2.

Particularly, the container 2 is provided in its upper portion with a compartment 13 for storing the pharmaceutical doses to be dispensed. Such compartment 13 is delimited by inner surfaces of front 22 and rear 23 walls and by inner surface of first side wall 24. Compartment 13 is also delimited by an inner surface of second side wall 25 not shown in FIG. 2.

In addition, the compartment 13 is accessible from outside through the lid 14 that can be opened.

Furthermore, the compartment 13 is delimited below by a first wall 15 declining from the inner surface of first side wall 24. Such first wall 15 is linked to a slipping wall 17 near the inner surface of rear wall 23. As shown in FIG. 2, the slipping wall 17 looks like a gutter declining towards a release opening 29.

Moreover, the first declining wall 15 is linked to a second wall 16 substantially declining from the inner surface of front wall 22 towards the release opening 29. It should be observed that the first 15 and second 16 walls with the slipping wall 17 define an alignment area for pharmaceutical doses stored in the compartment 13 itself.

In addition, the container 2 is provided under the slipping wall 17 with a housing 18 for a dispensing mechanism 19.

Particularly, such mechanism 19 comprises a sliding wall 21 suitable to slide over a fixed wall 30. Both walls 21 and 30 are, substantially, orthogonal as regards the front wall 22 and the sliding wall 21 can slide in a longitudinal sense from a closing position to a release position, and vice versa, allowing a pharmaceutical dose to be dispensed.

Both walls 21 and 30 are provided with openings 31 overlapped each other only in the release position. Furthermore, in the release position, the release opening 29 and such openings 31 are overlapped.

For example, such openings 31 may be circular holes having their diameter arranged in accordance with the corresponding diameter of pharmaceutical doses to be dispensed.

Furthermore, both walls 21 and 30 have rectangular shape and the fixed wall 30 comprises on three sides an elevated edge 30′. Such elevated edge 30′ forms a seat in which the sliding wall 21 can slide.

It should be observed that in the release position, i.e. with openings 31 overlapped, the release opening 29 communicates with an intermediate dispensing area 32 of cylindrical shape. In addition, such intermediate area 32 communicates with an exit area 33 for a dispensed pharmaceutical dose through an exit opening 34 which is opposite of openings 31.

As shown in FIG. 2, such exit area 33 is limited below by a slanted plate 33′ made, for example, of stainless steel. Further, the exit area 33 communicates with outside of container 2 through the delivery opening 27.

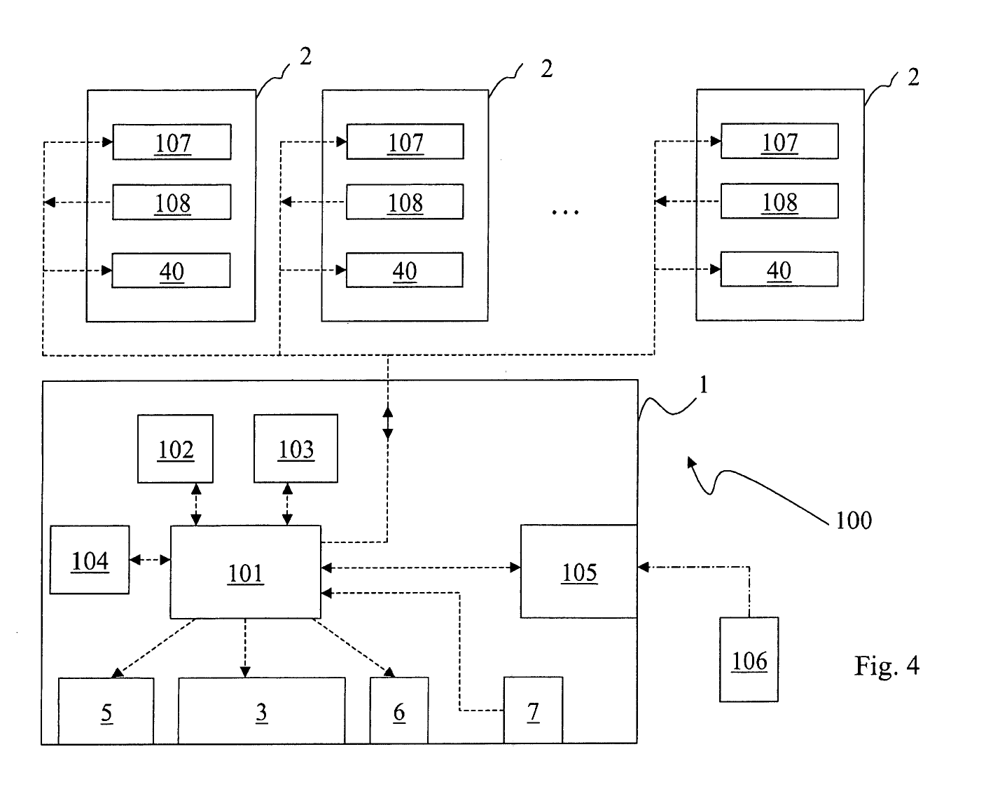

Moreover, the sliding wall 21 of dispensing mechanism 19 has an end 35 connected to a movable column 36. Particularly, such column 36 and the sliding wall 21 are orthogonal each other and they can be jointly moved by a suitable movement device (not shown in FIG. 2) provided in housing 18. For example, a geared motor at 3V DC can be used for moving both column 36 and sliding wall 21. Particularly, such geared motor is indicated in FIG. 4 with reference 107. The motor 107 may be activated/deactivated by the microcontroller 101 of dispenser 1 for producing a movement transferred to column 36.

Furthermore, the dispensing mechanism 19 comprises an adjustable slider 37 having a first end 38 connected with the movable column 36. Such slider 37 has a second free end 39 extending inside the intermediate dispensing area 32 substantially parallel as regards the sliding wall 21. Particularly, the slider 37 can be moved by geared motor 107 together with the sliding wall 21. In addition, such slider 37 is movable from bottom to top and vice versa for adjusting the height of the intermediate dispensing area 32 according to the individual pharmaceutical dose length (for example a pill length). In this way, only one pharmaceutical dose can enter the intermediate dispensing area 32 at any time.

Furthermore, adjustable slider 37 can be inserted/extracted in/from the intermediate area 32 when column 36 moves from the closing to the release/the release to the closing position, respectively.

In addition, the container 2 comprises a detector 108 for detecting the transit of a pharmaceutical dose through the exit opening 34. For example, such detector is a photoswitch 108 located in correspondence of such exit opening 34 and comprising a photodiode and emitter.

As known by those skilled in the art, the photoswitch 108 detects the transit of a pharmaceutical dose by means of an electronic beam created by such emitter through the intermediate dispensing area 32 near the exit opening 34.

The photoswitch 108 is interfaced with the microcontroller 101 for exchanging suitable transit signals in order to act as a counter of the pharmaceutical doses passed through the dispensing area 32.

Furthermore, the container 2 comprises a vibration device 40 located in such housing 18 under the slipping wall 17. For example, a suitable vibration device 40 is a vibration motor of coin-type such as the motor VM14B-S1produced by Etechno-Group. Such vibration motor 40 may be activated by microcontroller 101 of dispenser 1 in order to operate at the same time of the geared motor 107.

Advantageously, the activation of motor 40, for example, at a vibration frequency of 50 Hz, makes the pharmaceutical doses stored in the compartment 13 vibrate and allows the release of at least one pharmaceutical dose through the release opening 29.

In the following, the way to use the medication dispensing apparatus 100 of invention is described with reference to the former figures.

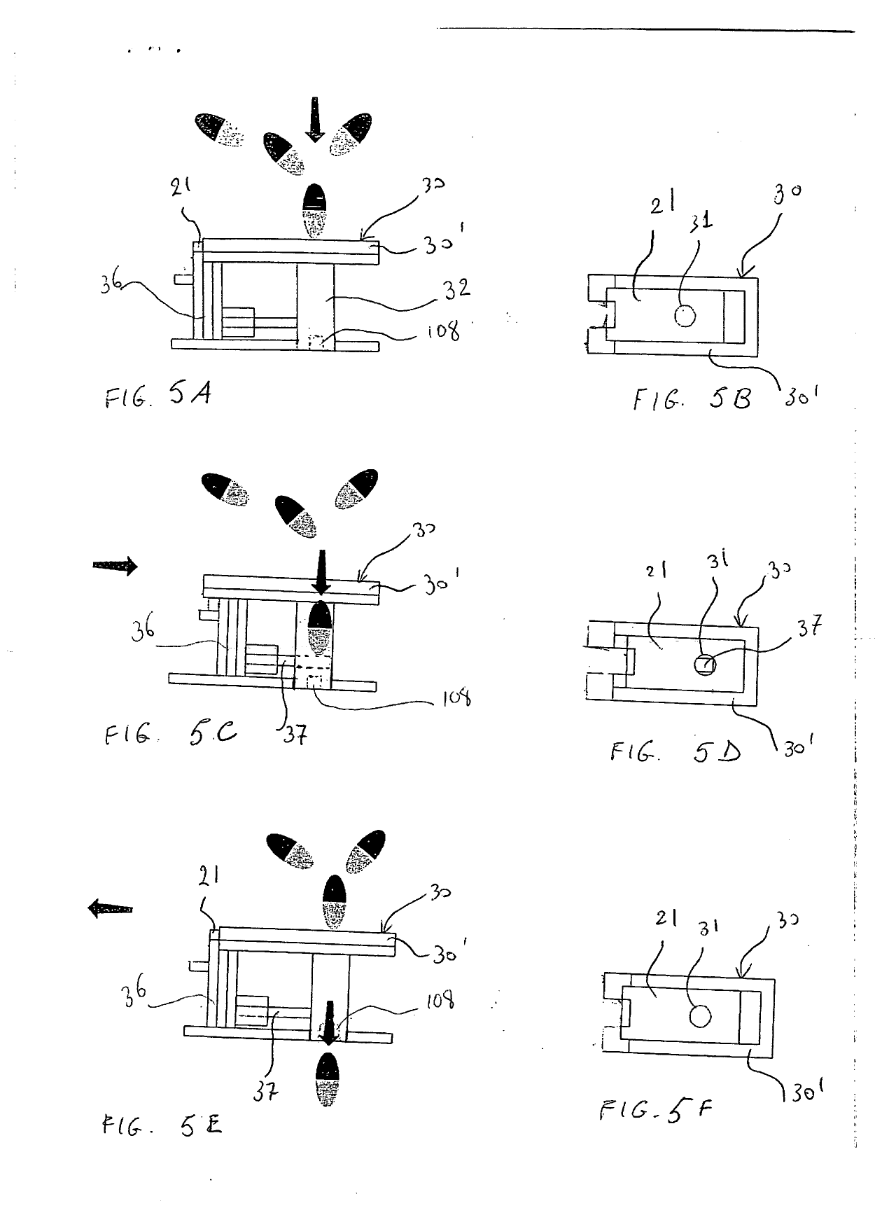

In addition, FIG. 5 A-F help to better understand how a pharmaceutical dose can be dispensed by apparatus 100.

Firstly, the patient has a consultation with a doctor bringing with him his own smart card 106 containing his medical history.

The doctor can access information stored in the card 106 by means of an electronic equipment, such as a personal computer (PC), provided with a device for reading/writing the smart card 106. At the same time, the doctor monitors the effectiveness of medications taken.

If needed, the doctor can update the smart card 106 by modifying or removing prescription related to dosage of a medication. Further, the doctor can write on the card 106 information on new types of pharmaceutical doses with their corresponding prescriptions.

Subsequently, the patient takes his updated smart card 106 to a pharmacist. The pharmacist is able to process information stored in such card 106 by means of a further electronic equipment provided with card reader/writer device. According to the information read on the smart card 106, the pharmacist prepares one or more containers 2 to be filled with the prescribed pharmaceutical doses.

Particularly, in a first time, for each different kind of pharmaceutical dose, the pharmacist evaluates the diameter of a single dose using a suitable measure tool. Depending on the measured diameter, the pharmacist chooses a container 2 provided with the appropriate dispensing mechanism 19. In other words, the sliding 21 and fixed 30 walls of the dispensing mechanism 19 may comprise overlapping holes 31 having at least the same diameter of measured dose.

In addition, after the evaluation of the length of pharmaceutical dose to be dispensed, the slider 37 of the dispensing mechanism 19 is adjusted according with such length.

Next, each container 2 is filled up according to the prescription, i.e. the prescribed number of pharmaceutical doses (pills, tablets and the like) are inserted in the compartment 13 through the opened lid 14.

Different kinds of pharmaceutical doses are put in different containers distinguishable each other by the translucent sections 28.

It should be observed that containers 2 can be filled up by pharmacist manually or using high capacity dispensing modules. Generally, such modules guarantee up to one year's supply for several patients.

In addition, the pharmacist gives verbal information to the patient on effects of the medication and on how to insert the containers 2 into the dispenser 1 located at home.

Alternatively, the pharmacist provides the patient with prescribed pharmaceutical doses in existing medication packaging, such as blisters, bottles and paper packaging. In this way, the patient himself can put, at home, the pharmaceutical doses in empty labelled containers 2 provided by the pharmacist.

Further, the pharmacist updates information stored in the smart card 106 by the further electronic equipment. Particularly, the pharmacist can record onto the card 106 both type and quantity of pharmaceutical doses given to the patient.

At home, the patient places the containers 2 filled up with medications into the dispenser 1.

Afterwards, prescription information memorized in the smart card 106 is transferred to the microcontroller 101 inserting the same card 106 in the reader/writer device 105 of dispenser 1.

It should be observed that the microcontroller 101 has been previously programmed and, for example, stores program information in the ROM memory 103. Therefore microcontroller 101 can determine in which container 2 a prescribed pharmaceutical dose is contained after receiving the prescription information.

Moreover, the patient can choose the audio (speaker 5) or visual (light 6) alarm that he prefers in addition to the information that appears on display 3. The patient can choose, also that both audio and visual alarm are activated at the same time.

The Real Time Clock Counter 104 provides the microcontroller 101 with timing information on the time of day. Therefore, according with data read from the smart card 106, the microcontroller 101 can determine the correct medical prescription time.

At such prescription time, microcontroller 101 activates the speaker 5 and/or LED 6. For example, the speaker 5 and LED 6 can run for one minute every five minutes for thirty minutes in all. Contemporary, the dispenser 1 indicates the type and number of pharmaceutical doses to be taken through display 3.

The patient can activate the automated dispensation of pharmaceutical doses pushing button 7 of dispenser 1, for example, within thirty minutes. In this way, the microcontroller 101 activates the geared motor 107 and the vibration motor 40 of one or more containers 2 to allow dispensation of the pharmaceutical doses contained within.

In a greater detail, the pharmaceutical doses stored in a container 2 are aligned in the slipping wall 17 under compartment 13 by the vibrations produced from the vibratory motor 40.

It should be observed that the sliding wall 21 of the dispensing mechanism 19 is normally in the closing position, i.e. openings 31 of sliding 21 and fixed 30 walls do not overlap. In this way, no pharmaceutical dose can pass through into the intermediate dispensing area 32. Such area 32 is kept clear of medication when not in use ensuring better hygiene as well as easy removal of doses stored in the container 2.

The geared motor 107, activated by microcontroller 101, drives the sliding wall 21 from the closing position to the release position so that a pharmaceutical dose can enter the intermediate dispensing area 32.

In the release position, the second end 39 of the adjustable slider 37 is inserted in the area 32 for stopping fall of pharmaceutical dose inside the same area 32.

Subsequently, the geared motor 107 drives the sliding wall 21 back from the release position to the closing position. At the same time the adjustable slider 37 is moved back and extracted from the intermediate area 32. In this way, the dispensed pharmaceutical dose falls onto the slanted plate 33′ and rolls down into the removable cup 9.

Further, photoswitch 108 informs microcontroller 101 with suitable transit signals that the pharmaceutical dose has been successfully dispensed. In this way, microcontroller 101 deactivates the geared motor 107.

On the contrary, if dispensation of the pharmaceutical dose fails, i.e. the microcontroller 101 has received no transit signal, the geared motor 107 turns again until the dose has passed through the exit opening 34.

In addition, microcontroller 101 stores the exact time in which the dose has been dispensed in the RAM memory 102.

If button 7 is not pressed by patient within thirty minutes, the apparatus 100 may activate optional functionalities to remedy prescription time not complied with.

For example, one optional functionality may include the activation of an additional reminding device such as a wireless portable device carried by user. The portable device can be worn around the neck, or arm or be part of a keychain. Furthermore, such portable device would contain LED and speaker alarm output options.

In a further optional functionality provided, the apparatus 100 may dispense medication up to a supplementary period of N hours from time prescribed. In this case, for each type of pharmaceutical dose to be dispensed, a value of N is stored on the smart card 106 for indicating the number of hours starting from the prescription time in which medications can be taken without consequences for patient.

In addition, the apparatus 100 may be provided with transmission apparatuses, for example an interface with a telephone line or a device for wireless communication.

In this way, the apparatus 100 can send messages to a doctor or to a relative of the patient, informing them that a prescription time has been missed and a dose has not been taken.

If a medication, made of one or more pharmaceutical doses, is not dispensed by apparatus 100 after the supplementary period of N hours, display 3 indicates the missed medication. Further, such missed medication is written in the RAM memory 102 of microcontroller 101.

Moreover, before ejecting the smart card 106 from the apparatus 100, all information related to medications taken or missed are written on the smart card 106 itself by the microcontroller 101.

The automated medication dispensing apparatus 100 of the invention has a lot of advantages over devices known in the art.

In fact, containers 2 for pharmaceutical doses provided with the dispensing mechanism 19 and vibration motor 40 allow easily dispensation of doses having different dimensions avoiding that doses stay blocked in the slipping wall 17 without sliding.

Moreover, the containers 2 used can be easily cleaned and reused with reduction of operating costs of the apparatus 100.

Other advantages of the apparatus 100 are:
improving communication doctor-pharmacist-patient;
improved monitoring of medication dispensing with reduction of errors related to taking medication as prescribed;
ease of use by the patient.

Obviously, to the dispensing apparatus of the present invention, those skilled in the art, aiming at satisfying contingent and specific requirements, may carry out further modifications and variations, all however being contemplated within the scope of protection of the invention, such as defined in the annexed claims.

1. Apparatus for automated dispensing of pharmaceutical doses in discrete solid form, such apparatus comprising:
at least a container provided with a compartment for storing the pharmaceutical doses to be dispensed;
dispenser associable with said at least a container for dispensing prescribed pharmaceutical doses according to medication dispensing information stored in portable memory; said dispenser being provided with reader/writer and processor devices for, respectively, reading and processing the information stored in such memory;
dispensing mechanism of said pharmaceutical doses including a first opening to put the storing compartment in communication with the dispenser, and
vibration device for making the pharmaceutical doses stored in the compartment vibrate and allowing the release of at least one pharmaceutical dose through the first opening.

2. Apparatus according with claim 1, wherein said vibration device is a vibration motor located in a housing provided in said container.

3. Apparatus according with claim 2, wherein said motor is of coin-type and can be activated by the processor device of dispenser to align by the vibration produced the pharmaceutical doses in a slipping wall under said compartment.

4. Apparatus according with claim 2, wherein said dispensing mechanism is placed in the housing of container and comprises a sliding wall suitable to slide over a fixed wall from a closing position to a release position for allowing a pharmaceutical dose to be dispensed.

5. Apparatus according with claim 4, wherein the sliding wall includes the first opening of dispensing mechanism and the fixed wall includes a second opening, said first and second openings overlapping each other in the release position.

6. Apparatus according with claim 5, wherein the first and the second openings are circular holes having at least the same diameter of a pharmaceutical dose to be dispensed.

7. Apparatus according with claim 5, wherein in the release position the first and second openings put in communication a release opening of the storing compartment with an intermediate dispensing area provided in the container.

8. Apparatus according with claim 7, wherein said intermediate dispensing area is of cylindrical shape and communicates with an exit area of container through an exit opening opposite said first and second openings.

9. Apparatus according with claim 7, wherein the dispensing mechanism comprises also an adjustable slider having an end extending inside said intermediate dispensing area in the release position for stopping fall of pharmaceutical dose inside the intermediate area.

10. Apparatus according with claim 9, wherein said adjustable slider is movable from bottom to top and vice versa to adjust the height of the intermediate dispensing area according to the length of an individual pharmaceutical dose.

11. Apparatus according with claim 9, wherein said adjustable slider can be moved from the closing position to the release position and vice versa to be inserted/extracted in/from the intermediate area.

12. Apparatus according with claim 9, wherein said sliding wall and adjustable slider can be moved by a movement device provided in the housing of container.

13. Apparatus according with claim 12, wherein said movement device is a geared motor suitable to be activated/deactivated by said processor device.

14. Apparatus according with claim 7, wherein said container comprises a detector located in correspondence of the exit opening of intermediate dispensing area for detecting the transit of a pharmaceutical dose.

15. Apparatus according with claim 14, wherein said detector is a photoswitch interfaced with processor device for exchanging transit signals and for acting as a counter of pharmaceutical doses passed.

16. Apparatus according with claim 1, wherein such pharmaceutical doses are pills, capsules, tablets or other medications of the like.

17. Apparatus according with claim 1, wherein the processor device is a microcontroller suitable to control all functions of the apparatus.

18. Apparatus according with claim 1, wherein such portable memory is a smart card.

19. Apparatus according with claim 1, also comprising audio and visual alarms, such as a speaker and a light, respectively, to indicate a prescription time.

20. Apparatus for automated dispensing of pharmaceutical doses in discrete solid form, such apparatus comprising:
at least a container provided with a compartment for storing the pharmaceutical doses to be dispensed;
dispenser associable with said at least a container for dispensing prescribed pharmaceutical doses according to medication dispensing information;
dispensing mechanism of said pharmaceutical doses including a first opening to put the storing compartment in communication with the dispenser, and
vibration device for making the pharmaceutical doses stored in the compartment vibrate and allowing the release of at least one pharmaceutical dose through the first opening.
